(19) United States
(12) Patent Application Publication
(10) Pub. No.: US 2018/0082340 A1
(43) Pub. Date: Mar. 22, 2018

(54) PAUSING AN ADVERTISEMENT

(71) Applicant: Google Inc., Mountain View, CA (US)

(72) Inventors: Martin Brandt Freund, Mountain View, CA (US); Yuanying Xie, Mountain View, CA (US)

(73) Assignee: Google Inc., Mountain View, CA (US)

(21) Appl. No.: 14/013,534

(22) Filed: Aug. 29, 2013

(51) Int. Cl. G06Q 30/02

(52) U.S. Cl. CPC G06Q 30/0277

(57) ABSTRACT

Video ads that play in connection with the presentation of requested videos can generally be skipped if the content consumer is not interested in watching the ad. However, it is common that the content consumer will let the ad play, but focus attention on a different task (e.g., checking email) until the requested content begins. A determination can be made based on input to a user interface that the presentation of the ad does not have the attention of the content consumer. In response, the presentation can be paused. If the user is not interested in watching the ad, the ad can be skipped, but if the user is interested, the ad will not be missed. Such can mitigate unnecessary expenses for advertisers where their ads are played, but ignored by the content consumer.

### TECHNICAL FIELD

This disclosure generally relates to automatically pausing an advertisement that is being presented on a user interface in response to input to the user interface that is determined to indicate a lack of engagement or attention.

### BACKGROUND

Video-based advertisements are often presented in connection with other video content. For example, when a user visits a video (or other media) content hosting site or service and selects a video to watch, it is common to serve a pre-roll ad that begins rolling before the selected video or to serve some other type of advertisement.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to pausing a presentation of an advertisement when it is inferred the presentation does not have sufficient attention. A communication component can be configured to receive media data associated with a media content item selected for presentation. The communication component can also receive ad data associated with an advertisement that is to be presented in connection with a presentation of the media content item. A presentation component can be configured to employ a user interface to provide a presentation of the advertisement based on the ad data. A pausing component can be configured to facilitate pausing the presentation of the advertisement in response to input to the user interface that is determined to indicate the presentation of the advertisement lacks attention.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a block diagram of an example system that can facilitate pausing a presentation of an advertisement in response to input that is determined to indicate a lack of attention in accordance with certain embodiments of this disclosure;

FIG. 2 illustrates a block diagram of an example system that illustrates additional features or aspects relating to pausing a presentation of an advertisement in response to input from a user interface in accordance with certain embodiments of this disclosure;

FIG. 3 illustrates a block diagram of an example system that can provide for determining whether or not a presentation of the advertisement lacks attention from a content consumer in accordance with certain embodiments of this disclosure;

FIG. 4 illustrates a block diagram of various examples of attention data that can be utilized to determine whether or not the presentation has a sufficient degree of attention in accordance with certain embodiments of this disclosure;

FIG. 5 illustrates a block diagram of an example system that provides an example of the disclosed subject matter in connection with an example user interface in accordance with certain embodiments of this disclosure;

FIG. 6 illustrates an example methodology that can provide for pausing an ad presentation in response to input that is determined to indicate a lack of attention in accordance with certain embodiments of this disclosure;

FIG. 7 illustrates an example methodology that can provide for additional features or aspects in connection with inferring a pause operation in accordance with certain embodiments of this disclosure;

FIG. 8 illustrates an example schematic block diagram for a computing environment in accordance with certain embodiments of this disclosure; and

FIG. 9 illustrates an example block diagram of a computer operable to execute certain embodiments of this disclosure.

### DETAILED DESCRIPTION

### Overview

Media content (e.g., video) hosting sites or services often serve an advertisement (e.g., a pre-roll ad) prior to presenting the requested content or at some point during the presentation of the requested content. In many cases, these advertisements, whether pre-roll or not, can be skipped either immediately or after a few seconds. Since the ads can be skipped, content consumers are generally not required to view the ad before viewing or returning to the requested content. Rather, the content consumer is afforded to opportunity to watch the ad if desired or to skip the ad otherwise.

Unfortunately, a very common scenario arises in which the content consumer is not interested in the advertisement, but does not skip the ad. Instead, the content consumer might read comments associated with the requested content (which might even scroll the presentation of the ad off the screen); switch to another task such as creating an email; or otherwise ignores the ad. As another example, the content consumer might be interested in the ad, but receive a phone call that prompts the content consumer to mute the presentation before answering the phone.

Such behavior is particularly disadvantageous to advertisers because the advertiser is usually charged while the ad is streaming, irrespective of whether the content consumer is paying attention to the ad. Therefore, it is often the case that the advertiser will prefer their ad be skipped by a user rather than the ad being played and ignored. However, it is generally presumed the content consumer is interested in the ad and paying attention to the ad. Otherwise, the content consumer would have skipped the ad. But as noted above, it is common for content consumer that is not interested in an ad (or otherwise engaged) to let the ad play while the content consumer focuses attention elsewhere.

In order to mitigate these or other issues, the disclosed subject matter can detect or determine that a content consumer is not engaged or no paying attention to an ad. In response, the advertisement being presented can be paused and remain paused until it is detected or determined that the content consumer is once again engaged in the presentation of the advertisement. Hence, content consumers not interested in the ad can skip the ad and content consumer interested in the ad, but temporarily engaged elsewhere (e.g., a phone call), can resume the ad where it was paused. In either case, the advertiser can be billed more appropriately.

In some embodiments, determining whether the content consumer is engaged with the presentation of the advertisement can be accomplished by examining the content consumer's transactions with the user interface that is presenting the advertisement. For example, if the content consumer minimizes the application (e.g., a browser) that is presenting the ad, then it can be inferred the content consumer is not paying attention to the ad and the ad can be automatically paused. The act of minimizing generally requires an input to the user interface (e.g., clicking a minimize button or other UI element), and such input or resultant actions or data can be employed to determine a lack of attention.

Numerous other examples can exist as well, some or all of which relate to or can be detected based on input to the user interface. For example, reducing or muting the volume, either globally for the user device or specifically for the application that is presenting the advertisement, can also indicate a lack of attention. If the presentation of the advertisement is scrolled off screen or otherwise occluded (e.g., by another user interface element) or the presentation of the advertisement is not a primary active element of the user interface (e.g., a different application such as an email application, window, or user interface element has primary focus), then such can be an indication of a lack of attention.

In some embodiments, when it is detected or determined that the presentation of the advertisement no longer lacks attention, then the ad can be automatically resumed or unpaused. In other embodiments, the ad might resume only in response to manual instruction to do so. In some embodiments, a feature to skip the ad can be presented in response to the return of user attention, which can be independent of time-based or other criterion that is typically satisfied prior to enabling the skip ad feature. Hence it is to be appreciated that the intent of some embodiments of the subject matter described herein is not necessarily focused on requiring the content consumer to view the ad, which might lead to dissatisfaction, but rather to remove advertising inefficiencies. Content consumers can now be less likely to miss advertisements that do interest them and more disposed to skip those that do not interest them.

### Example Systems of Pausing/resuming in Response to Attention

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

It is to be appreciated that in accordance with one or more implementations described in this disclosure, users can opt-out of providing personal information, demographic information, location information, proprietary information, sensitive information, machine information, or the like in connection with data gathering aspects. Moreover, one or more implementations described herein can provide for anonymizing collected, received, or transmitted data.

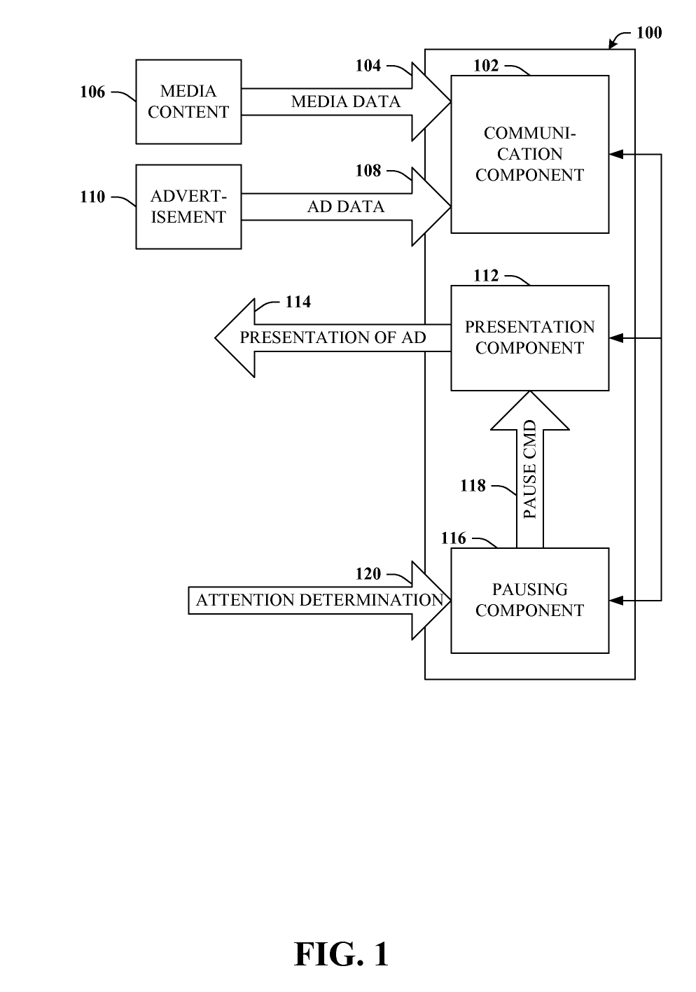

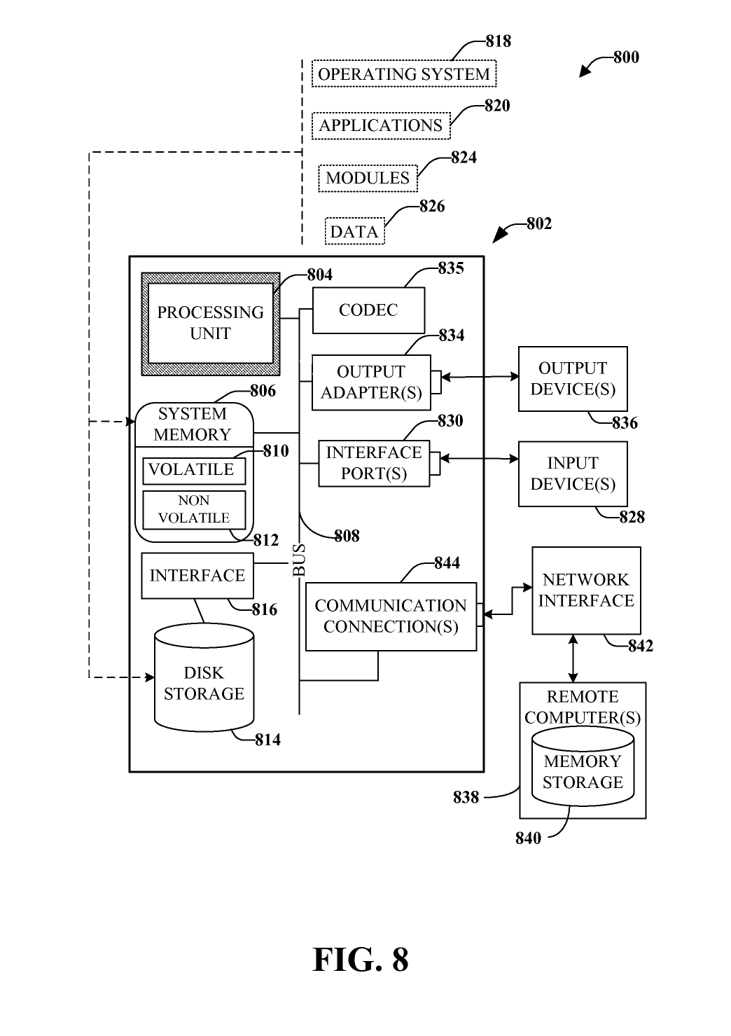

Referring now to FIG. 1, a system 100 is depicted. System 100 can, inter alia, facilitate pausing a presentation of an advertisement in response to input that is determined to indicate a lack of attention. Embodiments disclosed herein can, for example, increase the likelihood that a content consumer will skip an ad that is not interesting and be engaged with an ad that is interesting, which can lower costs or increase productivity associated with advertisements. System 100 can include a memory that stores computer executable components and a processor that executes computer executable components stored in the memory, examples of which can be found with reference to FIG. 8. It is to be appreciated that the computer 802 can be used in connection with implementing one or more of the systems or components shown and described in connection with FIG. 1 and other figures disclosed herein. As depicted, system 100 can include a communication component 102, a presentation component 112, and a pausing component 116.

Communication component 102 can be configured to receive media data 104 associated with a media content 106 item that is selected for presentation. Communication component 102 can also receive ad data 108 associated with an advertisement 110 that is to be presented in connection with a presentation of the media content 106. For example, advertisement 110 can be a pre-roll ad that is presented prior to the presentation of the media content 106, or a different type of ad such as an ad that is presented after some portion of media content 106 has been presented.

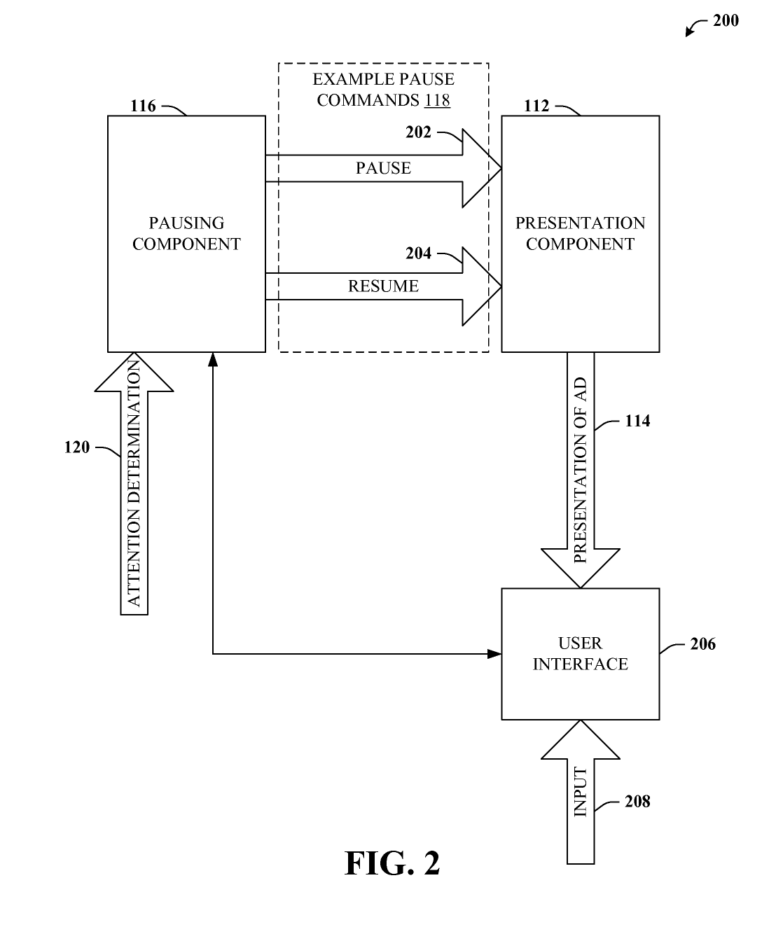

Presentation component 112 can be configured to employ a user interface to provide a presentation 114 of advertisement 110 based on ad data 108. Pausing component 116 can be configured to facilitate pausing the presentation 114 of advertisement 110. Such can be accomplished by way of pause command 118 that can be transmitted to presentation component 112. Pausing component 116 can transmit pause command 118 and/or facilitate pausing of presentation 114 in response to input to the user interface that is determined to indicate the presentation 114 of the advertisement 110 lacks attention from a content consumer that requested media content 106. Additional detail in connection with pause command 118, the user interface and associated input that can be used to determine a lack of attention is further detailed with reference to FIG. 2.

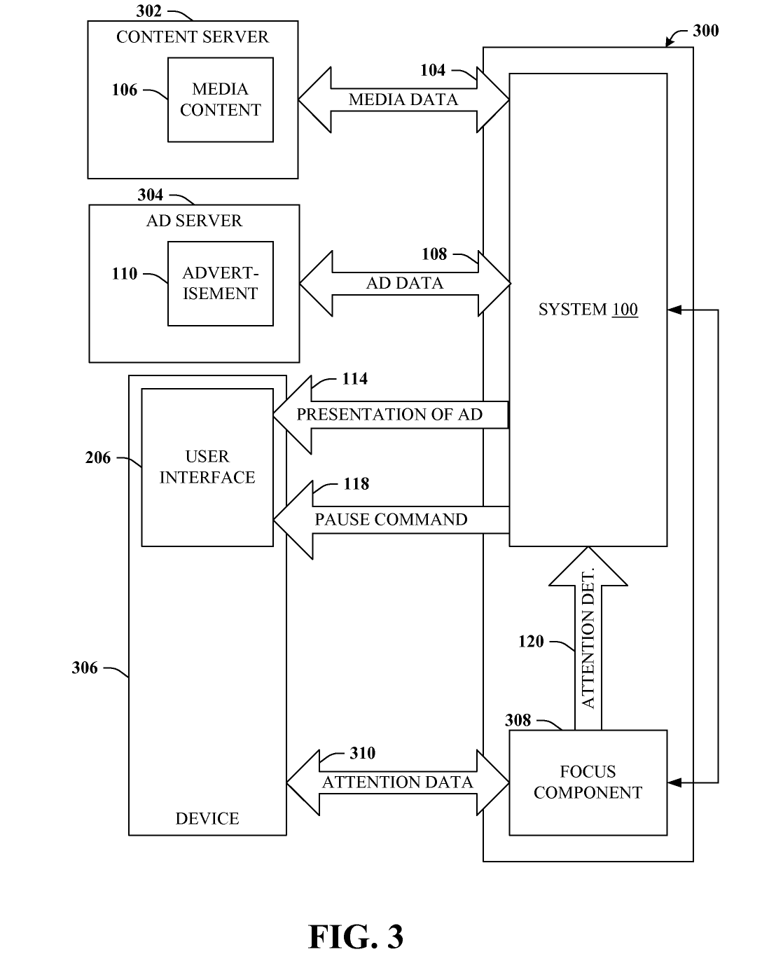

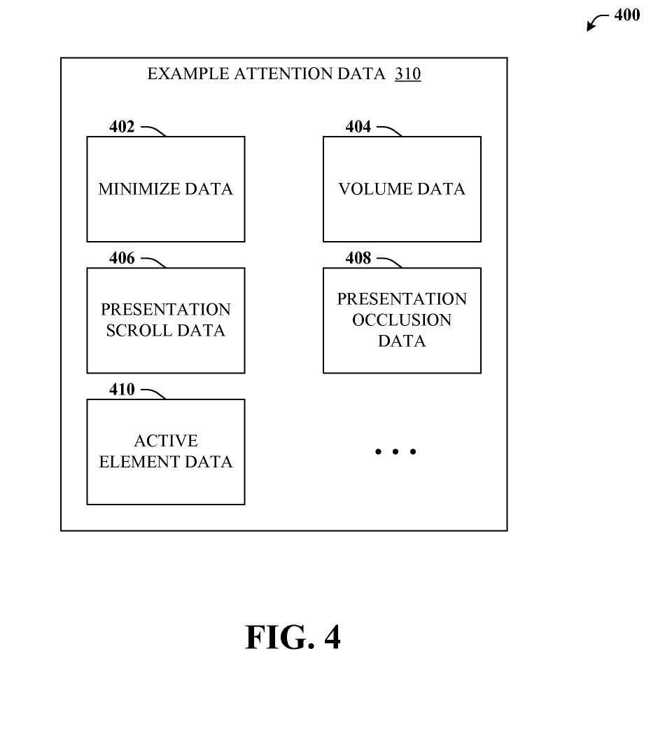

Whether presentation 114 lacks attention, has regained, or lost the focus of attention can be determined by other components detailed herein and is further detailed in connection with FIGS. 3 and 4. However, once that determination has been made, associated data or instructions (e.g., attention determination 120) can be forwarded to pausing component 116.

While still referring to FIG. 1, but referring also to FIG. 2, system 200 is provided. System 200 illustrates additional features or aspects relating to pausing a presentation of an advertisement in response to input from a user interface. System 200 can include the components detailed in connection with FIG. 1, or herein. For example, system 200 can include presentation component 112 that can employ user interface 206 to provide presentation 114 of advertisement 110. System 200 can also include pausing component 116 that can issue pause command 118 to presentation component 112.

Attention determination 120 (e.g., whether presentation 114 lacks attention or not) can be inferred based on input 208 to user interface 206. Such input 208 is not intended to include input that expressly pauses or otherwise affects presentation 114 (e.g., the content consumer manually pauses presentation 114), but rather other input 208 from which it can be inferred that presentation 114 lacks the attention of the content consumer. Various non-limiting examples of input 208 are further discussed in connection with FIGS. 3 and 4.

As noted supra, pausing command 118 can include instructions based on the data included in attention determination 120. For example, if it is determined that a content consumer associated with user interface 206 in which advertisement 110 is being presented withdraws attention from presentation 114, then attention determination 120 can include data indicating presentation 114 lacks attention. In response, pausing component 116 can transmit pause instruction 202 to presentation component 112, which can facilitate a pausing operation associated with presentation 114. As another example, if it is determined that the content consumer returns attention to presentation 114, then attention determination 120 can include data indicating presentation 114 has attention or no longer lacks attention. In that case, pausing component 116 can transmit resume instruction 204 to presentation component 112, which can facilitate resuming or unpausing presentation 114 on user interface 206. Hence, it is understood that pause command 118 can include instructions to pause, resume, or otherwise affect presentation 114.

In some embodiments, presentation 114 need not be automatically resumed in response to attention determination 120 indicating that presentation 114 has regained the attention of the content consumer. Rather, presentation 114 can remain paused until such is manually overridden, for instance, by selection of a user interface element that plays or unpauses the presentation.

Referring now to FIG. 3, system 300 is depicted. System 300 can provide for determining whether or not a presentation of advertisement 110 lacks attention from a content consumer. System 300 can include all or a portion of system 100 as well as other systems or components detailed herein. Hence, system 300 can include communication component 102 (depicted in FIG. 1) that can receive media data 104 associated with a media content 106 item. Media content 106 and/or associated media data 104 can be received from content server 302. Communication component 102 can also receive ad data 108 associated with advertisement 110. Advertisement 110 and/or ad data 108 can be received from ad server 304. All or portions of content server 302 and ad server 304 can be included in a content hosting site or service that stores media content 106, potentially uploaded by a content creator, curator, or other authorized entity, and enables content consumers access to media content 106 as well as advertisement(s) 110.

Presentation component 112 (depicted in FIGS. 1 and 2) can employ user interface 206 to provide presentation 114 of advertisement 110 based on ad data 108. User interface 206 can be included in device 306 that can be associated with the content consumer that requested media content 106. Both presentation 114 of the advertisement 110 and a presentation of media content 106 can be provided to user interface 206.

System 300 can also include focus component 308 that can be configured to determine that presentation 114 of advertisement 110 (or another presentation) lacks attention. Focus component 308 can also determine that presentation 114 has regained attention and/or no longer lacks attention. In any case, the attention information inferred by focus component 308 can be provided to system 100 (e.g., pausing component 116) by way of attention determination 120. Based on the type of information included in attention determination 120, system 100 can issue pause command 118 (e.g., an instruction to pause or resume presentation 114, e.g., issued by pausing component 116 and received by presentation component 112), which can be forwarded to user interface 206 and/or device 306.

Focus component 308 can determine that presentation 114 lacks attention and/or construct attention determination 120 based on attention data 310 that can be received from device 306 and/or user interface 206. Non-limiting examples of attention data 310 are provided in connection with FIG. 4.

With reference now to FIG. 4, illustration 400 depicts various examples of attention data 310 that can be utilized to determine whether or not presentation 114 has a sufficient degree of attention. For example, focus component 308 can determine presentation 114 (or another aspect of user interface 206) lacks attention in response to minimize data 402 that indicates presentation 114 is minimized, typically due to input to user interface 206 that instructs the application or an associated display to be visibly removed from the user interface 206.

As another example, focus component 308 can determine presentation 114 either has or lacks attention based on volume data 404. For instance, if the volume setting is low or reduced or is muted, then such can be used to infer a lack of attention. The volume can relate to a global setting for device 306 or for a particular application such as a media player in which advertisement 110 is presented. Presentation scroll data 406 and presentation occlusion data 408 can be other examples of attention data 310. If presentation 114 is scrolled so that all or a portion leaves the visible user interface 206 or if another application or user interface element (e.g., a window) occludes presentation 114, then such attention data 310 can be identified and employed to infer attention determination 120.

Active element data 410 can also represent attention data 310. For example, most user interfaces (e.g., user interface 206) track an active user interface element for various reasons such as to determine which interface element is to receive input. If a text editor application and an email application are both running on a device, and the user begins typing input via a keyboard, then the keyboard commands will routed to the application that is active, but not to the application that is not active. Generally, when a user requests media content (e.g., media content 106), then a browser with an embedded media player or another application used to access the media content will be the active user interface element.

Suppose a pre-roll ad (e.g., advertisement 110) is served to the browser and begins playback (e.g., presentation 114), at which point the content consumer switches to an email application to read an email. Upon switching to the email application, the user interface (e.g., user interface 206) or another component of an associated device (e.g., device 306) will switch the active user interface element from the browser to the email application. Associated data can be provided to focus component 308 as attention data 310, from which it can be inferred that presentation 114 lacks attention (e.g., since the user selected the email application while advertisement 110 was being presented).

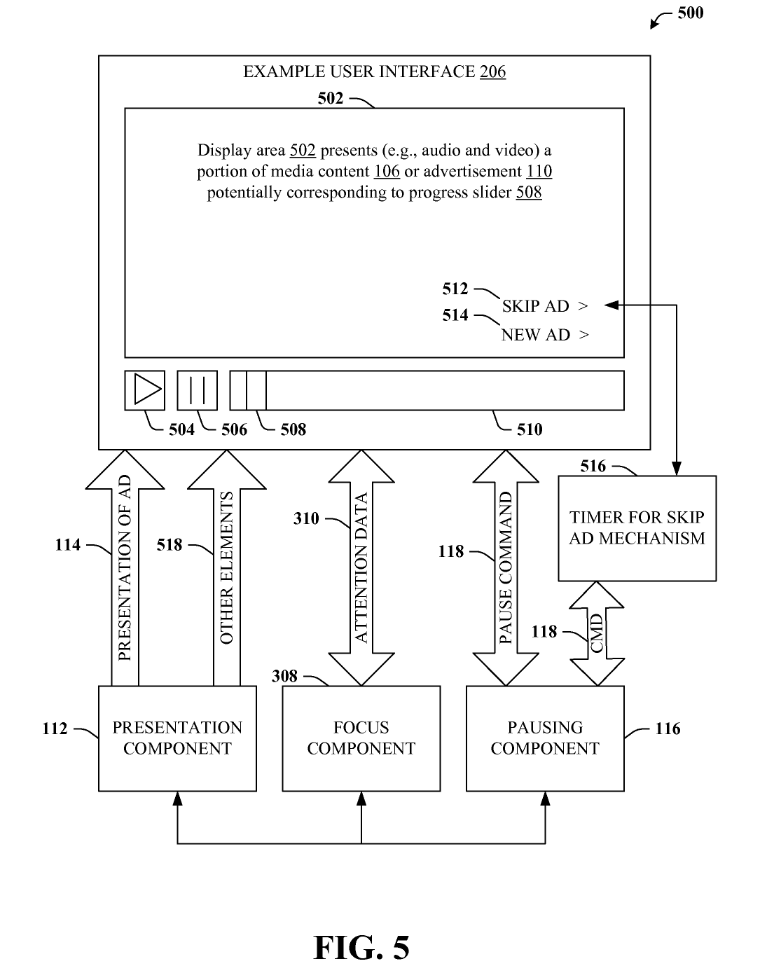

Turning now to FIG. 5, system 500 is depicted. System 500 provides an example of the disclosed subject matter in connection with an example user interface 206. User interface 206 can include a display area 502 that can present media content 106 and advertisement 110, a play button or element 504, a pause element 506, and a progress slider 508 that can scroll the length of progress bar 510 that can be scaled to a length of time associated with content that is queued for presentation. Continuing the example above, suppose media content 106 is selected for presentation. However, before media content 106 is displayed, a pre-roll advertisement 110 is selected. Presentation component 112 can provide presentation 114 to user interface 206 and such can be presented in display area 502. Presentation component 112 can also provide instructions to display other elements 518. For example, a skip ad mechanism 512 can be provided, a new ad mechanism 514 can be provided, as well as others.

In some embodiments, skip ad mechanism 512 can be provided in response to a determination that presentation 114 lacks attention. For example, if it is inferred a content consumer is not engaged with presentation 114 resulting in pausing presentation 114, when the content consumer's attention returns to presentation 114, presentation 114 can resume and also provide skip ad mechanism 512, even in cases where such might not otherwise be available. In certain embodiments, skip ad mechanism 512 can be automatically selected upon detection that presentation 114 has regained attention. For instance, in cases where attention data 310 indicates the content consumer is not interested in advertisement 110 as opposed to indicating that the content consumer is merely temporarily engaged (e.g., an important phone call inferred from a mute of the volume, etc.).

In some embodiments, skip ad mechanism 512 can be provided immediately at the initiation of presentation 114 or can become visible or active after some determined time (e.g., after 5 seconds). In the latter case, skip ad mechanism 512 can be activated and/or become visible on user interface 206 after the expiration of a timer 516 for skip ad mechanism 512. In some embodiments, selection of skip ad mechanism 512 can result in instructions to terminate presentation 114 of advertisement 110 and invoke a presentation of media content 106. If the content consumer is potentially interested in an advertisement, but not the advertisement being presented, new ad mechanism 514 can be selected. Such can result in instructions to terminate presentation 114 of advertisement 110 and invoke a different presentation 114 of a different advertisement 110.

Consider the case where attention data 310 indicates that volume associated with presentation 114 is muted and that another user interface element becomes the active element that occludes display 502 two seconds into presentation 114. In that case, focus component 308 can determine that presentation 114 lacks attention and provide associated attention determination 120 to pausing component 116 that indicates presentation 114 should be paused (since it is inferred to lack attention), by way of pause command 118, which is issued either by pausing component 116 or presentation component 112. In response, presentation 114 that is being presented via display area 502 can be paused at the two second mark.

Suppose that after a few minutes, the volume is unmuted and the application that includes display area 502 is no longer occluded, which can be received by way of attention data 310. In response, focus component 308 can infer there is no longer a lack of attention and provide pausing component 116 with associated data (e.g., attention determination 120). Pausing component 118 can issue another pause command 118 that can include instructions to resume presentation 114 on display 502 at the point at which the presentation was paused (e.g., after two seconds).

Further suppose that content hosting policy is to only enable skip ad mechanism 512 after 10 seconds. In some embodiments, skip ad mechanism 512 can be enabled prior to expiration of the 10 second timer 516, such as immediately upon determination that presentation 114 no longer lacks attention (e.g., after only two seconds in this example). In other embodiments, presentation 114 might be required to continue running for eight more seconds before skip ad mechanism 512 is enabled. Accordingly, in addition to transmitting pause command 118 to user interface 206 (or device 306), a similar pause command 118 can be transmitted to timer 516. Therefore, timer 516 can count time only while advertisement 110 is running and/or only when it is determined presentation 114 does not lack attention.

### Example Methods for Pausing/resuming in Response to Attention

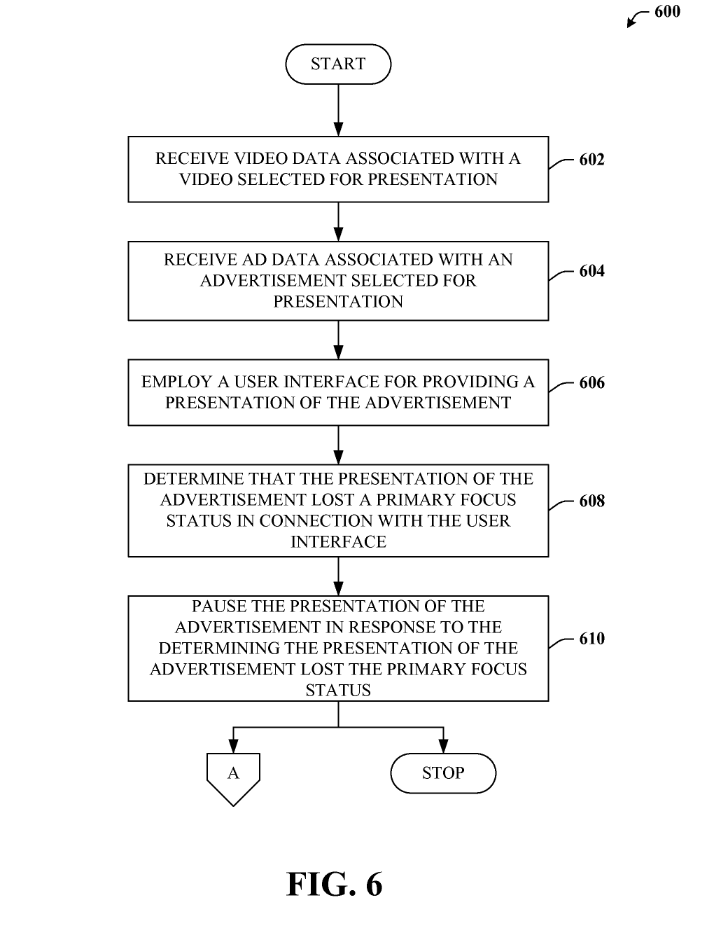

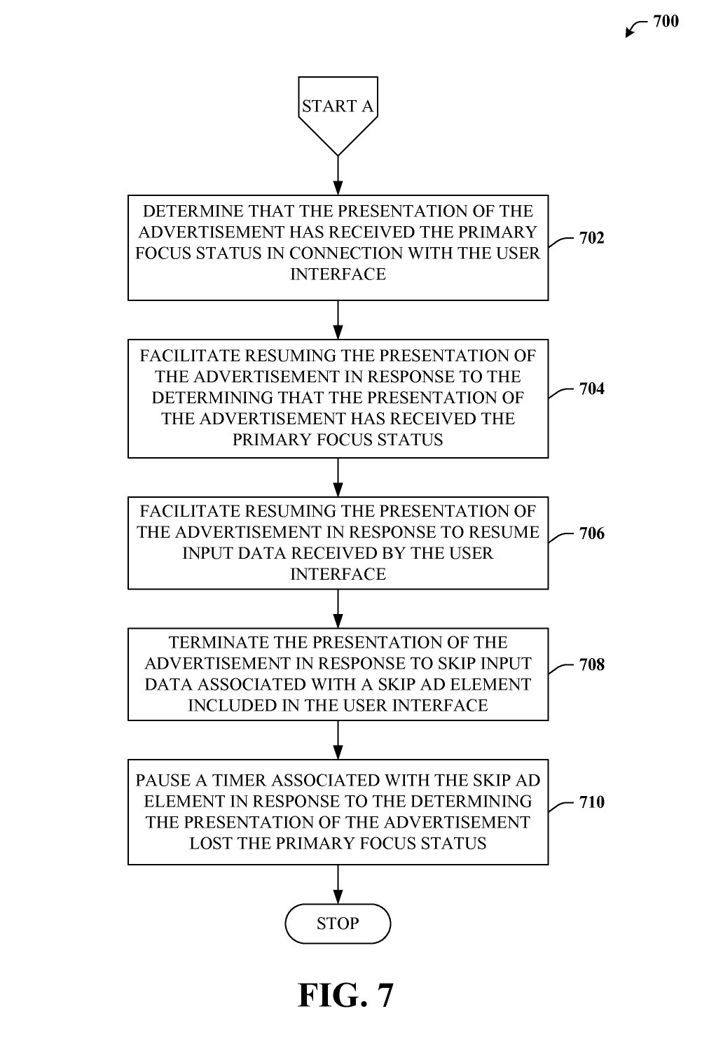

FIGS. 6 and 7 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

FIG. 6 illustrates exemplary method 600. Method 600 can provide for pausing an ad presentation in response to input that is determined to indicate a lack of attention. For example, at reference numeral 602, video (or other media content) data associated with a video selected for presentation can be received (e.g., by a communication component). For example, a content consumer visiting a content hosting site or service can select a particular video to view. In response, various data relating to the media content can be received in preparation of a presentation of the media content.

At reference numeral 604, ad data associated with an advertisement that is to be presented in association with a presentation of the video can be received (e.g., by the communication component). The advertisement can be a pre-roll advertisement that is presented prior to the presentation of the media content, or a different type of advertisement such as one that is presented after some portion of media content has been presented.

At reference numeral 606, a user interface can be employed for providing a presentation of the advertisement (e.g., by a presentation component). At reference numeral 608, it can be determined that the presentation of the advertisement lost a focus status in connection with the user interface (e.g., by a focus component). For example, various indicators from the user interface that is presenting the advertisement can be utilized to infer whether the presentation has attention or focus. Thus, determination that the focus status is lost can be constructed in response to input to the user interface.

At reference numeral 610, the presentation of the advertisement can be paused (e.g., by a pausing component) in response to the determining the presentation of the advertisement lost the focus status. Method 700 can end or proceed to insert A.

Turning now to FIG. 7, exemplary method 700 is depicted. Method 700 can provide for additional features or aspects in connection with inferring a pause operation. Method 700 can begin at the start of insert A. At reference numeral 702, it can be determined that the presentation of the advertisement has received (e.g., regained after losing in reference numeral 608 of FIG. 6) the focus status in connection with the user interface.

At reference numeral 704, resuming the presentation of the advertisement can be facilitated in response to the determination at reference numeral 702 that the presentation of the advertisement has received the focus status. Additionally or alternatively, resuming the presentation of the advertisement can be facilitated in response to input data received by the user interface (e.g., a user manually unpauses the paused presentation), which is illustrated by reference numeral 706.

At reference numeral 708, the presentation of the advertisement can be terminated in response to skip input data associated with a skip ad element included in the user interface. At reference numeral 710, a timer associated with the skip ad element can be paused in response to the determining the presentation of the advertisement lost the focus status. Method 700 ends.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 8, a suitable environment 800 for implementing various aspects of the claimed subject matter includes a computer 802. The computer 802 includes a processing unit 804, a system memory 806, a codec 835, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI) or others now in existence or later developed.

The system memory 806 includes volatile memory 810 and non-volatile memory 812. The basic input/output system (BIOS), containing the basic routines to transfer information between elements within the computer 802, such as during start-up, is stored in non-volatile memory 812. In addition, according to present innovations, codec 835 may include at least one of an encoder or decoder, wherein the at least one of an encoder or decoder may consist of hardware, software, or a combination of hardware and software. Although, codec 835 is depicted as a separate component, codec 835 may be contained within non-volatile memory 812 or included in other components detailed herein. By way of illustration, and not limitation, non-volatile memory 812 can include read only memory (ROM), programmable ROM (PROM), electrically programmable ROM (EPROM), electrically erasable programmable ROM (EEPROM), or flash memory. Volatile memory 810 includes random access memory (RAM), which acts as external cache memory. According to present aspects, the volatile memory may store the write operation retry logic (not shown in FIG. 8) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), resistive RAM (RRAM), or others now in existence or later developed.

Computer 802 may also include removable/non-removable, volatile/non-volatile computer storage medium. FIG. 8 illustrates, for example, disk storage 814. Disk storage 814 includes, but is not limited to, devices like a magnetic disk drive, solid state disk (SSD) floppy disk drive, tape drive, flash memory card, or memory stick. In addition, disk storage 814 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 814 to the system bus 808, a removable or non-removable interface is typically used, such as interface 816. It is appreciated that storage devices 814 can store information related to a user. Such information might be stored at or provided to a server or to an application running on a user device. In one embodiment, the user can be notified (e.g., by way of output device(s) 836) of the types of information that are stored to disk storage 814 and/or transmitted to the server or application. The user can be provided the opportunity to opt-in or opt-out of having such information collected and/or shared with the server or application (e.g., by way of input from input device(s) 828).

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer system 802. Applications 820 take advantage of the management of resources by operating system 818 through program modules 824, and program data 826, such as the boot/shutdown transaction table and the like, stored either in system memory 806 or on disk storage 814. It is to be appreciated that the claimed subject matter can be implemented with various operating systems or combinations of operating systems.

A user enters commands or information into the computer 802 through input device(s) 828. Input devices 828 include, but are not limited to, a pointing device such as a mouse, stylus, touch pad, keyboard, microphone, joystick, game pad, satellite dish, scanner, TV tuner card, digital camera, digital video camera, web camera, and the like. These and other input devices connect to the processing unit 804 through the system bus 808 via interface port(s) 830. Interface port(s) 830 include, for example, a serial port, a parallel port, a game port, and a universal serial bus (USB). Output device(s) 836 use some of the same type of ports as input device(s) 828. Thus, for example, a USB port may be used to provide input to computer 802 and to output information from computer 802 to an output device 836. Output adapter 834 is provided to illustrate that there are some output devices 836 like monitors, speakers, and printers, among other output devices 836, which require special adapters. The output adapters 834 include, by way of illustration and not limitation, video and sound cards that provide a means of connection between the output device 836 and the system bus 808. It should be noted that other devices and/or systems of devices provide both input and output capabilities such as remote computer(s) 838.

Computer 802 can operate in a networked environment using logical connections to one or more remote computers, such as remote computer(s) 838. The remote computer(s) 838 can be a personal computer, a server, a router, a network PC, a workstation, a microprocessor based appliance, a peer device, a smart phone, a tablet, or other network node, and typically includes many of the elements described relative to computer 802. For purposes of brevity, only a memory storage device 840 is illustrated with remote computer(s) 838. Remote computer(s) 838 is logically connected to computer 802 through a network interface 842 and then connected via communication connection(s) 844. Network interface 842 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 844 refers to the hardware/software employed to connect the network interface 842 to the bus 808. While communication connection 844 is shown for illustrative clarity inside computer 802, it can also be external to computer 802. The hardware/software necessary for connection to the network interface 842 includes, for exemplary purposes only, internal and external technologies such as, modems including regular telephone grade modems, cable modems and DSL modems, ISDN adapters, and wired and wireless Ethernet cards, hubs, and routers.

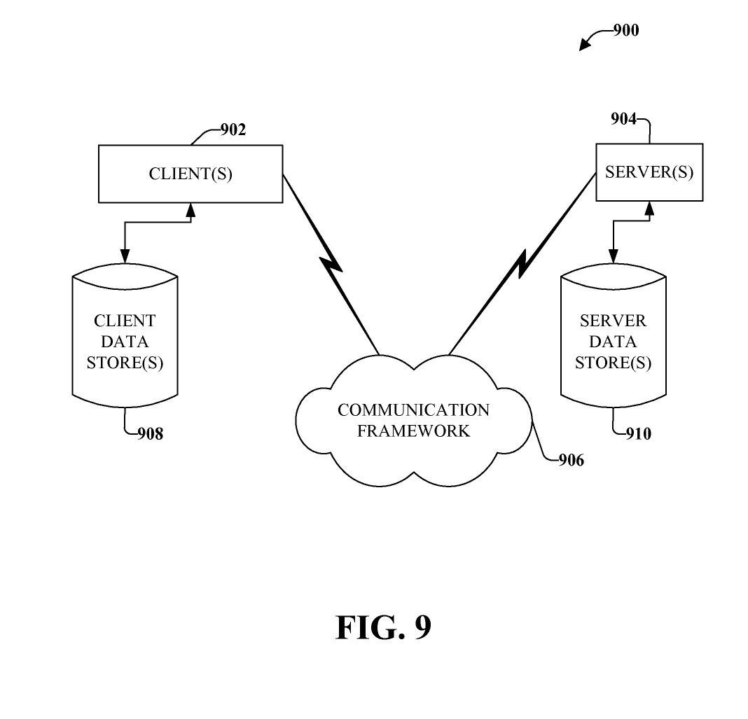

Referring now to FIG. 9, there is illustrated a schematic block diagram of a computing environment 900 in accordance with this specification. The system 900 includes one or more client(s) 902 (e.g., laptops, smart phones, PDAs, media players, computers, portable electronic devices, tablets, and the like). The client(s) 902 can be hardware and/or software (e.g., threads, processes, computing devices). The system 900 also includes one or more server(s) 904. The server(s) 904 can also be hardware or hardware in combination with software (e.g., threads, processes, computing devices). The servers 904 can house threads to perform transformations by employing aspects of this disclosure, for example. One possible communication between a client 902 and a server 904 can be in the form of a data packet transmitted between two or more computer processes wherein the data packet may include video data. The data packet can include a cookie and/or associated contextual information, for example. The system 900 includes a communication framework 906 (e.g., a global communication network such as the Internet, or mobile network(s)) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

In one embodiment, a client 902 can transfer an encoded file, in accordance with the disclosed subject matter, to server 904. Server 904 can store the file, decode the file, or transmit the file to another client 902. It is to be appreciated, that a client 902 can also transfer uncompressed file to a server 904 and server 904 can compress the file in accordance with the disclosed subject matter. Likewise, server 904 can encode video information and transmit the information via communication framework 906 to one or more clients 902.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A system, comprising:
a memory that stores computer executable components; and
one or more microprocessors that execute the following computer executable components stored in the memory:
a communication component that receives media data associated with a media content item selected for presentation and ad data associated with an advertisement that is presented in connection with a presentation of the media content item;
a presentation component that presents the advertisement through a user interface and based on the ad data;
a focus component that determines that the advertisement lacks user attention by determining at least one of: i) an audio volume being used to present the advertisement is below a threshold volume, ii) a difference between an audio volume being used to present the advertisement at a present time and an audio volume being used to present the advertisement at a later time is above a threshold difference, or iii) an audio volume being used to present the advertisement is muted; and
a pausing component that pauses the presentation of the advertisement in response to the focus component determining that the presentation of the advertisement lacks user attention.

2. The system of claim 1, wherein the focus component determines whether the advertisement temporarily lacks user attention by i) identifying an application that currently has user attention, and ii) determining that there is a change in an audio volume being used to present the advertisement and
wherein the pausing component resumes presenting the advertisement in response to i) determining that the advertisement temporarily lacks user attention, and ii) a determination that the presentation of the advertisement no longer lacks attention.

3. The system of claim 2, wherein the resuming the presentation of the advertisement is in response to a resume presentation instruction input to the user interface.

4-5. (canceled)

6. The system of claim 1, wherein the presentation of the advertisement includes a skip ad mechanism that, in response to selection, instructs the presentation component to terminate the presentation of the advertisement and invoke the presentation of the media content item; and includes a different ad mechanism that, in response to selection, instructs the presentation component to terminate the presentation of the advertisement and invoke a different presentation of a different advertisement.

7. The system of claim 6, wherein the pausing component pauses a timer associated with the skip ad mechanism in response to the determination that the presentation of the advertisement lacks attention.

8. The system of claim 7, wherein the pausing component resumes the timer associated with a defined time period in response to a determination that the presentation of the advertisement no longer lacks attention.

9. The system of claim 7, wherein the presentation component presents the skip ad mechanism or the different ad mechanism in response to a determination that the presentation of the advertisement no longer lacks attention.

10. A method, comprising:
employing a computer-based processor to execute computer executable components stored in a memory to perform the following:
receiving video data associated with a video selected for presentation;
receiving ad data associated with an advertisement that is presented in association with a presentation of the video;
presenting the advertisement through a user interface and based on the ad data;
determining that a presentation of the advertisement lost a focus status in connection with the user interface in response to input to the user interface by determining at least one of: i) an audio volume being used to present the advertisement is below a threshold volume, ii) a difference between an audio volume being used to present the advertisement at a present time and an audio volume being used to present the advertisement at a later time is above a threshold different, or iii) an audio volume being used to present the advertisement is muted; and
pausing the presentation of the advertisement in response to the determination that the presentation of the advertisement lost the focus status.

11. The method of claim 10, further comprising receiving the video data and the ad data from a media content hosting site or service by way of a communications network.

12. The method of claim 10, further comprising:
determining that the advertisement temporarily lacks user attention by i) identifying an application that currently has user attention, and ii) determining that there is a change in an audio volume being used to present the advertisement and
determining that the presentation of the advertisement no longer lacks attention by determining that the presentation of the advertisement has received the focus status in connection with the user interface.

13. The method of claim 12, further comprising resuming the presentation of the advertisement in response to the determining that the presentation of the advertisement has received the focus status.

14. The method of claim 10, further comprising resuming the presentation of the advertisement in response to resume input data received by the user interface.

15. The method of claim 10, further comprising terminating the presentation of the advertisement in response to skip input data associated with a skip ad element included in the user interface.

16. The method of claim 15, further comprising pausing a timer associated with the skip ad element in response to the determining the presentation of the advertisement lost the focus status.

17-20. (canceled)

21. A client device, comprising:
a memory device;
a display that presents a user interface; and
one or more microprocessors that execute computer executable components stored in the memory device, wherein execution of the components causes the client device to perform operations comprising:
receiving, from a server, instructions to present media content;
presenting, through the user interface of the display, the media content;
pausing the presentation of the media content based on a determination that the media content has lost user attention by determining at least one of: i) an audio volume being used to present the media content is below a threshold volume, ii) a difference between an audio volume being used to present the media content at a present time and an audio volume being used to present the media content at a later time is above a threshold difference, or iii) an audio volume being used to present the media content is muted;
resuming the presentation of the media content based on a determination that (a) the advertisement temporarily lacks user attention by i) identifying an application that currently has user attention, and ii) determining that there is a change in an audio volume being used to present the advertisement, and (b) the media content has regained the user attention.

22. The client device of claim 21, wherein execution of the components causes the client device to perform operations comprising: presenting, through the user interface, a skip mechanism that terminates the presentation of a portion of the media content and presents other content in response to selection.

23. The client device of claim 22, wherein execution of the components causes the client device to perform operations comprising:
pausing a timer associated with the skip mechanism based on the determination that the media content has lost user attention; and
resuming the timer associated with the skip mechanism based on the determination that the media content has regained the user attention.

24. The system of claim 6, wherein the skip ad mechanism, in response to the determination that the presentation of the advertisement lacks user attention, instructs the presentation component to terminate the presentation of the advertisement and invoke the presentation of the media content item even in cases where a skip ad mechanism is not provided by a content provider associated with the advertisement.

25. The system of claim 6, wherein the different ad mechanism, in response to the determination that the advertisement lacks user attention, instructs the presentation component to terminate the presentation of the advertisement and invoke a different presentation of a different advertisement even in cases where a different ad mechanism is not provided by a content provider associated with the advertisement.
